(19) United States
(12) Patent Application Publication
(10) Pub. No.: US 2007/0273977 A1
(43) Pub. Date: Nov. 29, 2007

(54) Resin Optical Member and Method for Manufacturing the Same

(75) Inventors: Hiroyuki Nemoto, Minato-ku (JP); Shiro Sato, Minato-ku (JP)

Correspondence Address: RATNERPRESTIA, P O BOX 980, VALLEY FORGE, PA, 19482-0980, US

(73) Assignee: NIPPON SHEET GLASS COMPANY, LIMITED, TOKYO JAPAN 105-8552 (JP)

(21) Appl. No.: 10/561,350

(22) PCT Filed: Jun. 15, 2004
(86) PCT No.: PCT/JP04/08674

§ 371 Date: Mar. 7, 2007

(30) Foreign Application Priority Data
Jun. 19, 2003 (JP) 2003-174178

(51) Int. Cl. G02B 1/04; B29D 11/00; G02B 3/02

(52) U.S. Cl. 359/664; 264/1.36; 264/1.37; 359/642

(57) ABSTRACT

A method for manufacturing a resin optical component in which a light-shielding may easily be formed is provided. A laser beam is focused on a given position in the resin having a high light transmittance to concentrate the energy to the focal point, resulting in a small dot-like discolor by carbonization of resin. A component of small dot-like discolored portions are formed in the resin to provide a light-shielding wall having a high light absorptance in the interior of the resin having a high light transmittance. The light-shielding wall may remove the stray light which is the light that is obliquely incident on a lens, passes through the lens array plate in a thickness direction thereof, and outgoes from the neighbored lenses.

### TECHNICAL FIELD

The present invention relates to a resin optical component and a method for manufacturing the same, particularly to a resin lens array plate and a manufacturing the same.

### BACKGROUND ART

As a resin lens array plate which is an optical component comprising an aperture stop and a light-shielding function to suppress a stray light, the structure having a light-shielding layer consisting of a light absorbing film among neighbored micro lenses, and the structure having a light-shielding layer formed on the surface opposing to a micro lens array surface have been conventionally known in the art.

The following methods to form this light-shielding layer have been proposed, i.e., the photolithography using a photoresist including a light absorbing agent (see Japanese patent publication No. 2002-277610), the method in which a light-absorbing coating material is coated on the entire lens array surface and then only the coating material on lenses is removed (see Japanese patent publication No. 2001-311802), the method in which a light-absorbing coating material is coated by means of an ink jet technique on the area where the light-shielding layer is formed (see Japanese patent publication No. 2001-330709), and the method in which a groove is formed at the portion where a light-shielding layer is provided and then a light-absorbing coating material is filled in the groove.

However, the conventional method have problems such that an effective removing of a stray light may not be realized by the light-shielding layer formed on the surface of a lens array plate or on the surface opposing to a lens array surface. The reason thereof is that if a light-shielding layer is formed around a lens, among neighbored lenses, or on the surface opposing to a micro lens array surface, the light-shielding layer is effective to remove the light incident from outside of a lens area, and the light (which is obliquely incident on a lens) outgoing from the outside of a lens, but the light-shielding layer may not remove the stray light which is the light that is obliquely incident on a lens, passes through the lens array plate in a thickness direction thereof, and outgoes from the neighbored lenses. As a result, the problems such that a ghost image is caused and a resolution is poor. Also, complex steps are required for the method for forming a light-shielding layer by filling a light-absorbing coating material into a groove.

### DISCLOSURE OF INVENTION

An object of the present invention is to resolve the problems and to provide a resin optical component in which a stray light may be effectively removed.

A first aspect of the present invention is a resin optical component. The resin optical component is made of resin having a high transmittance with respect to light in a required wavelength band, and resin portions discolored by energy in an absorption wavelength band of the resin constitutes a high light absorptance portion.

A second aspect of the present invention is a method for manufacturing a resin optical component made of resin having a high transmittance with respect to light in a required wavelength band. In the method, energy in an absorption wavelength band of the resin is supplied to the interior of the resin from the energy source to form a high light absorptance portion by discoloring a portion of the resin by the supplied energy.

### BRIEF DESCRIPTION OF THE DRAWINGS

FIG. 1A is a plan view of the resin lens array plate.

FIG. 1B is a cross-sectional view taken by X-X line in FIG. 1A.

FIG. 2 is a plan view of a part of the resin lens array plate body.

FIG. 3A is a plan view for illustrating a method for forming the light-shielding walls.

FIG. 3B is a cross-sectional view taken along Y-Y line in FIG. 3A.

FIG. 4 is a cross-sectional view for illustrating the formation of a low reflectivity film.

FIG. 5 is a plan view for illustrating the formation of a light-absorbing film.

### BEST MODE FOR CARRYING OUT THE INVENTION

The embodiments of a resin lens array plate in accordance with the present invention will now be described.

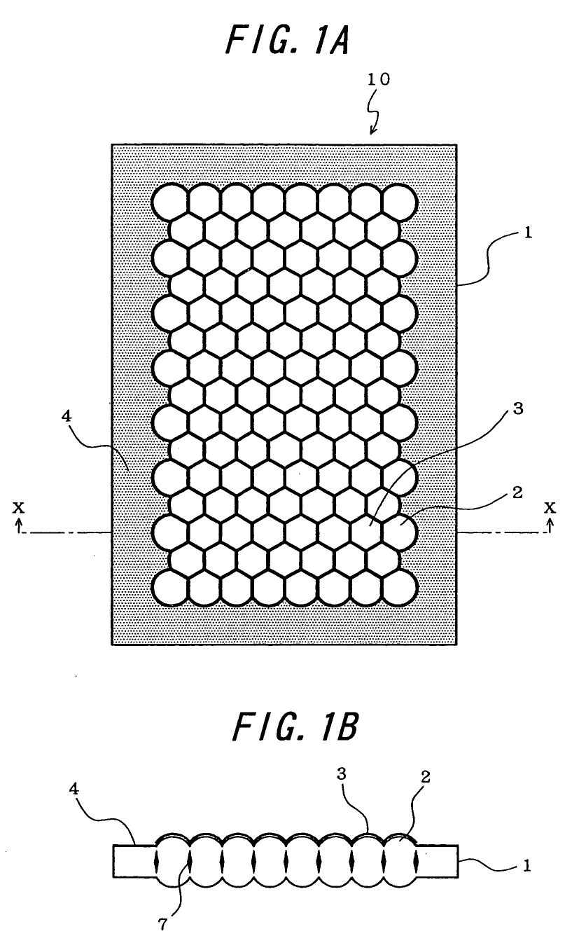

FIG. 1A shows a rectangular resin lens array plate 10 structuring an erect lens array used for an area display device for a three-dimensional image or two-dimensional image, a device for projecting an image to a screen, and an image transfer device forming an image on light-receiving elements or photosensitive components. FIG. 1B is a cross-sectional view taken by X-X line in FIG. 1A.

The material of a plate body 1 structuring the resin lens array plate 10 is required to be usable for an injection molding, to have a high light transmittance with respect to the light in a desired wavelength band, and to have a low water absorbency. A cycloolefin-based resin is used as the material of the plate body 1 in the present embodiment. The plate 10 has lens forming areas at its center portion on both sides thereof. Convex micro lenses 2 each having a spherical surface are densely arrayed in the lens forming areas. In the example in FIG. 1, the lens array is a hexagonal close-packed array which is desirable for a small aberration at a peripheral portion of a lens and a large amount of light to be transmitted. A hexagonal close-packed lens array is a lens array which has six extending directions viewed from one convex micro lens. The shape of a convex micro lens is hexagonal in a hexagonal close-packed lens array.

Respective light axes of the convex micro lenses 2 formed on one side of the lens array plate are coincident with respective light axes of the convex micro lenses 2 formed on the other side thereof.

The portion having a high light absorptance is formed in the resin among neighbored convex micro lenses to provide a light-shielding wall 7 for removing a stray light. The light-shielding wall 7 is formed along the perpendicular bisector to the line segment connecting the centers of neighbored two lenses 2, i.e., at the boundary between neighbored two lenses. The light-shielding wall 7 has a width of approximately 0.05 mm and a depth of approximately 0.1 mm from the surface.

The depth of the light-shielding wall 7 is required to be one-third or more the thickness of the lens array plate body 1, because a leakage of the stray light is caused if the depth is smaller than one-third the thickness of the lens array plate body 1.

A low reflectivity film 3 is formed on the surface of the lens array plate body 1 to decrease the reflectivity of the resin lens array plate 10. The low reflecting film 3 may be formed by using a material having a refractive index lower than that of the lens array plate body 1. Examples of such material are silica compound, fluorine-based resin, and so on. Such low reflectivity film 3 does not cause the light transmittance of the lens array plate body 1 to decrease.

A mask consisting of a light-absorbing film 4 is formed outside the lens forming area on one side of the plate body 1 to prevent the stray light incident from the outside of the lens forming area. The mask may also be formed on both sides of the lens array plate body 1. In this case, preventing the stray light incident from the outside of the lens forming area may be effectively realized.

While the low reflectivity film 3 and light-absorbing film 4 are formed in the embodiment, those films are not necessarily needed.

According to the resin lens array plate 10 having the structure described above, the portion having a high light absorptance is formed in the resin among neighbored convex micro lenses to provide the light-shielding wall 7 for removing a stray light, so that the stray light obliquely incident on the lens may be effectively removed.

While the resin lens array plate 10 is made of cycloolefin resin in the embodiment, olefin-based resin, norborunene-based resin, and the like may also be used as the material of the plate. ZEONEX® and ZEONORE® of ZEON Corporation, ARTON® of JSR Corporation are commercially available for those resins.

While the convex micro lens is a spherical lens in the embodiment, the convex micro lens may be an aspherical lens.

Also, the array of convex micro lens may be a square close-packed array which is a lens array which has four extending directions viewed from one convex micro lens. The shape of a convex micro lens is square in a square close-packed lens array.

Furthermore, it is possible that the array of convex micro lens is not close-packed array, but rough-packed structure in which there is a space between lenses. In this case, the shape of a convex micro lens is typically circular, but is not limited thereto. In the case of a rough-packed structure in which there is a space between lenses, a light-shielding wall may be formed among convex micro lenses.

While the convex micro lenses are formed on both sides of the resin lens array plate, the convex micro lenses may be formed on one side only of the resin lens array plate.

Lenses also may be lenticular lenses which are arrayed in parallel or at a predetermined angle to the peripheral edge of the resin lens array plate.

As a method for preventing the stray light incident from the outside of the lens forming area, a light-absorbing aperture frame may be provided. This frame has apertures which do not cover the lens forming area.

A method for manufacturing the resin lens array plate 10 as shown in FIG. 1 will now be described.

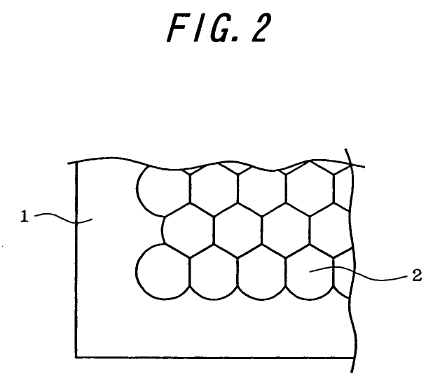

First, the resin lens array plate body 1 is fabricated by an injection molding. In the present embodiment, the resin lens array plate 1 is made of cycloolefin-based resin. FIG. 2 shows a part of the fabricated lens array plate body 1.

The lens array plate body 1 fabricated by an injection molding comprises lens forming areas at the central portions on both sides of the plate, in which spherical micro lenses 2 are arrayed in a close-packed way.

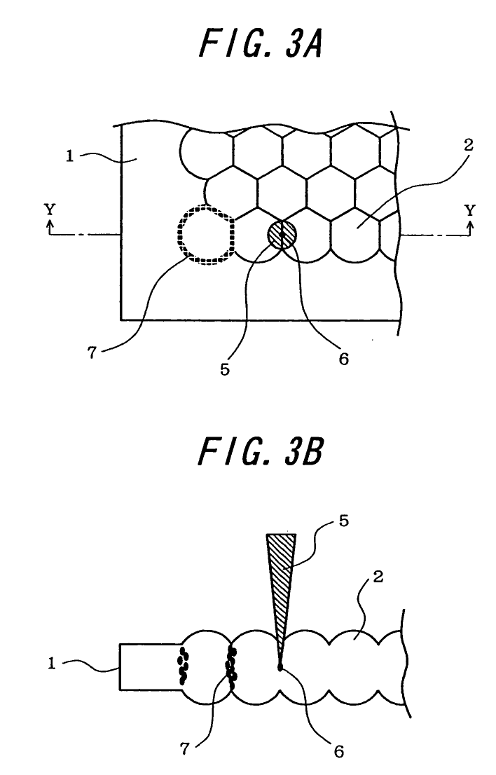

Next, the light-shielding walls are formed in the lens array plate body 1. FIGS. 3A and 3B illustrate a method for forming the light-shielding walls. FIG. 3A is a plan view of the plate 1 and FIG. 3B a cross-sectional view taken along Y-Y line in FIG. 3A.

The light-shielding walls may be formed by discoloring the resin, for this purpose an energy at an absorption wavelength band of the resin is used. In this embodiment, a laser beam is utilized.

A laser beam is focused on a given position in the resin having a high light transmittance to concentrate the energy to the focal point, resulting in a small dot-like discolor by carbonization of resin.

In the case that convex micro lenses 2 are arrayed in a hexagonal close-packed way, the laser beam 5 is irradiated to the boundary among the lenses as shown in FIGS. 3A and 3B. A laser beam having 532 nm wavelength is irradiated by using YVO₄ laser oscillator as an energy source. The irradiation condition of the laser beam is preferably a pulse oscillation on the basis of 0.7-1.7 kW and 10-100 kHz. In the present embodiment, the laser beam of 1 kW and 20 kHz is collected to the beam spot diameter of 0.01 mm and is focused on the position at the intermediate depth of the resin lens array plate body 1.

The laser beam is irradiated while repeating the scan thereof at a rate of 800 mm/sec, so that a number of very small discolored dots 6 are formed due to the carbonization of resin.

The discolored dots 6 are distributed before and behind the beam axis with the focal point of the beam being centered. As a result, the light-shielding portion 7 is formed in the resin having a high light transmittance by a number of distributed discolored dots 6.

The width of the formed light-shielding wall 7 is approximately 0.05 mm and the depth from the surface of the plate body 1 approximately 0.1 mm. This depth is one-third or more the thickness of the plate.

In the case of the array of a rough-packed structure in which there is a space between lenses, the light-shielding wall is formed along the periphery of the convex micro lens.

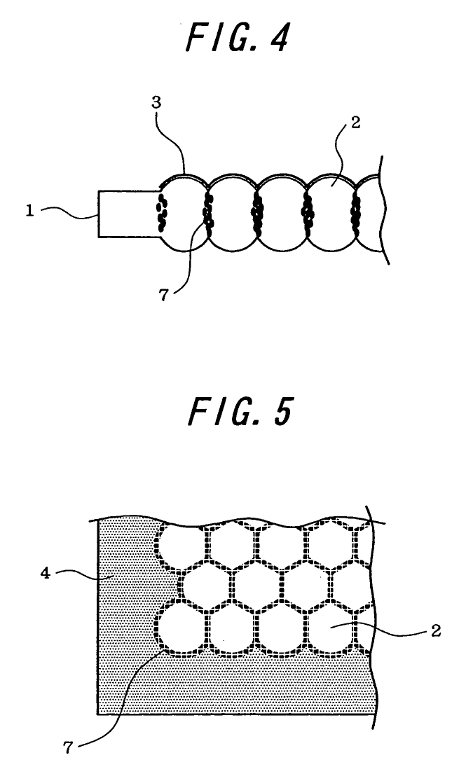

Next, as shown in FIG. 4, a low reflectivity film 3 is formed on the surface of the lens forming area of the resin lens array plate body 1 in order to decrease the reflectivity of the resin lens array plate 10. For example, the low reflectivity film 3 is formed of a silica compound by contacting the lens forming area of the plate body 1 to the aqueous solution of hydro silicofluoric acid (H₂SiF₆) including an oversaturated concentration of silica (SiO₂).

Next, as shown in FIG. 5, a mask of the light-absorbing film 4 is formed on the area outside the lens forming area on one side of the plate body 1 in order to prevent the stray light incident from the outside of the lens forming area. In this case, after forming the light-absorbing film on the area including the lens forming area or the entire surface of the plate body 1, a photosensitive material such as a black resist including carbon is formed on the area outside the lens forming area as a mask by photolithography.

While an injection molding is used to form the lens array plate, the present invention is not limited thereto. For example, the lens array plate may be formed by means of an extrusion molding, and then convex micro lenses may be formed on both side of the plate by means of embossing. In this case, the light-shielding walls may be formed by irradiating a laser beam to the lens array plate formed by means of an extrusion molding.

If the low reflectivity film and light-absorbing film are not required, then the steps for forming these films are not needed.

### INDUSTRIAL APPLICABILITY

According to the resin optical component of present invention, the light-shielding walls formed by the dots discolored by energy are provided in the resin lens array plate, the stray light obliquely incident on a lens is interrupted by therefore the light-shielding walls so that the stray light does not impinge on the neighbored lenses. The stray light may be effectively removed in this way, the problems such that a ghost image is caused and a resolution is poor are not caused in a display device utilizing the resin lens array plate, for example.

Also, according to the method for manufacturing the resin optical component of the present invention, the light-shielding walls are formed by irradiating energy such as a laser beam into the resin lens plate, so that the resin optical component may be easily manufactured without complex steps.

1. A resin optical component made of resin having a high transmittance with respect to light in a required wavelength band, comprising:
resin portions which are discolored by energy in an absorption wavelength band of the resin, wherein
the discolored resin portion constitutes a high light absorptance portion.

2. A resin optical component according to claim 1, wherein
the resin optical component is a resin lens consisting of a spherical or aspherical convex micro lens, and
the high light absorptance portion is formed in the resin outside an area for transmitting the light and constitutes a light-shielding wall for interrupting a stray light.

3. A resin optical component according to claim 1, wherein
the resin optical component is a resin lens array plate comprising a plurality of spherical or aspherical convex micro lenses which are arrayed at a predetermined pitch, and
the high light absorptance portion is formed in the resin among neighbored convex micro lenses and constitutes a light-shielding wall for interrupting a stray light.

4. A resin optical component according to claim 1, wherein
the resin optical component is a resin lens array plate comprising a plurality of spherical or aspherical convex micro lenses which are arrayed at a predetermined pitch, and
the high light absorptance portion is formed in the resin among the respective peripheries of neighbored convex micro lenses and constitutes a light-shielding wall for interrupting a stray light.

5. A resin optical component according to claim 3 or 4, wherein the light-shielding wall is formed one-third or more the thickness of the resin lens array plate in a thickness direction thereof.

6. A resin optical component according to any one of claims 1-4, wherein the resin is a cycloolefin-based resin, olefin-based resin, or norborunene-based resin.

7. A method for manufacturing a resin optical component made of resin having a high transmittance with respect to high in a required wavelength band, comprising the steps of:
supplying energy in an absorption wavelength band of the resin to the resin, and
forming a high light absorptance portion by discoloring a portion of the resin by the supplied energy.

8. A method for manufacturing a resin optical component according to claim 7, wherein the energy is light or radiation.

9. A method for manufacturing a resin optical component according to claim 8, wherein the energy is a laser beam.

10. A method for manufacturing a resin optical component according to claim 7, wherein the resin optical component is a resin lens consisting of a spherical or aspherical convex micro lens, and the high light absorptance portion is formed in the resin outside an area for transmitting the light and constitutes a light-shielding wall for interrupting a stray light.

11. A method for manufacturing a resin optical component according to claim 7, wherein the resin optical component is a resin lens array plate comprising a plurality of spherical or aspherical convex micro lenses which are arrayed at a predetermined pitch, and the high light absorptance portion is formed in the resin among neighbored convex micro lenses and constitutes a light-shielding wall for interrupting a stray light.

12. A method for manufacturing a resin optical component according to claim 7, wherein the resin optical component is a resin lens array plate comprising a plurality of spherical or aspherical convex micro lenses which are arrayed at a predetermined pitch, and the high light absorptance portion is formed in the resin among the respective peripheries of neighbored convex micro lenses and constitutes a light-shielding wall for interrupting a stray light.

13. A method for manufacturing a resin optical component according to claim 11 or 12, wherein the light-shielding wall is formed one-third or more the thickness of the resin lens array plate in a thickness direction thereof.

14. A method for manufacturing a resin optical component according to any one of claims 7-12, wherein the resin is a cycloolefin-based resin, olefin-based resin, or norborunene-based resin.
